(19) United States
(12) Patent Application Publication
(10) Pub. No.: US 2010/0268394 A1
(43) Pub. Date: Oct. 21, 2010

(54) Method and apparatus for a hybrid energy saving system

(76) Inventor: Daniel Richard Anderson, Albuquerque, NM (US)

Correspondence Address: Daniel Richard Anderson, 2401 Violet SW, Albuquerque, NM, 87105, US

(21) Appl. No.: 12/386,158

(22) Filed: Apr. 15, 2009

(51) Int. Cl. G06F 1/32

(52) U.S. Cl. 700/288

(57) ABSTRACT

Disclosed is a Hybrid Energy Storage System capable of increasing the energy recovery, lowering the environmental impact of CO2 release, decreasing the environmental impact of noise and visual pollution, simplifying the machine design and construction, smoothing the load on the mechanical system, and decreasing the material, design, and implementation costs. The System will store the needed energy in a battery-capacitor system, feed the energy to an electric motor during the high load portion of the load cycle, and retrieve electrical energy during the low load portion of the cycle. Sensor and switching systems will connect and disconnect the electric generator and electric motor systems at the appropriate parts of the cycle. Energy losses will be made up by solar panels, a wind generator, a gas engine, or connection to the electric grid. The System will save energy, lower costs of insulation and operation, and decrease the environment impacts.

### BACKGROUND OF THE INVENTION

1. Field of the Invention

The present invention relates to a Hybrid Energy Savings System for high load-low load machines (examples are water or oil well pumps) which returns a large part of the energy used in the high load portion of the cycle to the energy storage device (example is a battery.) during the low load portion of the cycle and eliminates the need for running the engine during the low load portion of the cycle.

2. Description of Prior Art

Constant load machines are very numerous throughout the industrial world. U.S. Patent Number 20070052242 describes an attempt to retrieve electrical energy from these constant load machines. If the machine is operating at optimal efficiency (100 percent) there will be no waste (excess) energy to convert back into electrical energy. Thus, this patent is describing a kind of a perpetual motion machine which cannot exist.

U.S. Patent Number 20070075545 describes an attempt to construct an electrical generating system using the cast off parts from an oil or water extraction system but not on an operating well. Water and oil well pumps have been in existence for more than 50 years and their structure and operation cannot be patented. With all of the mechanical and friction losses in the system described in the above patent (over 50%) it would be more energy efficient and environmentally friendly (less carbon dioxide release) to burn the natural gas or gasoline directly to do the required work. The invention does not address the energy stored in the pumping of the oil or water during the high load portion of the cycle which is the driver for our invention and does not address the energy savings due to the energy recovery during the low load portion of the cycle. This patent does not optimize the pump design and material savings due to the softening of the load on the equipment by the extraction of the stored (potential) energy during the low load cycle, nor does the patent optimize the counter balance weight loading to maximize the energy recovery during the low load portion of the cycle.

U.S. Patent Number 20080157534 describes an attempt to construct an electrical generating system using the cast off parts from an oil or water extraction system but not on an operating well. Water and oil well pumps have been in existence for more than 50 years and their structure and operation cannot be patented. It is not an operating well or pump system but just uses the parts from a well. With all of the mechanical and friction losses in the system described in the above patent (over 50%) it would be more energy efficient and environmentally friendly (less carbon dioxide release) to burn the natural gas or gasoline directly to do the required work. The invention does not address the pumping of the oil or water which is the driver for our invention and does not address the energy savings due to the energy recovered during the low load portion of the cycle. This patent does not optimize the pump design and material savings due to the softening of the load on the equipment by the extraction of the stored (potential) energy during the low load cycle, nor does the patent optimize the counter balance weight loading to maximize the energy recovery during the low load portion of the cycle.

### SUMMARY OF THE INVENTION

High load-low load machines are also very numerous throughout the industrial world. The conventional method of operating these machines is to run them at a level which fully utilizes the engine's power on the high load portion of the cycle. The engine continues to run at the same high power level during the low load portion of the cycle which wastes energy. The invention described in this patent will eliminate the need and methods of running the engines at high load rates at all times and in addition will convert much of the kinetic energy used in the high load portion of the cycle back into potential energy in the electrical storage system (battery) during the low load cycle.

The present invention is a Hybrid Energy Saving System which can be used on any machine which has high load-low load parts of the cycle. Energy will be supplied from an energy storage system (battery, battery-capacitor) to an electric motor on the high load portion of the cycle. On the low load portion of the cycle the system will return energy to the storage system from the generator. Energy losses will be made up by recharging the battery from the electric grid, from solar panels, from wind turbines, or gasoline, natural gas, or diesel engines. The present invention includes a sophisticated array of sensors to control the energy flow to and from the storage system, the high load, high energy use portion of the cycle and the low load, energy generation portion of the cycle, and the system for making up for energy losses in the system.

The Hybrid Energy Saving System can be connected to the rest of the machine by a belt and pulley system, a set of cables, an axle, a piston, or any other device that can transmit mechanical or hydraulic energy from the Hybrid Energy Saving System to the part of the machine which is doing the work.

It is, therefore, a primary objective of the present invention to provide a Hybrid Energy Saving System which will significantly enhance the efficiency, cost savings and operation quality of any high load-low load system.

It is another objective of the present invention to provide a Hybrid Energy Saving System which will significantly enhance the energy recovery from high load-low load systems at a significant savings of energy and decrease the local and global environment impacts (carbon footprint-Global Warming) of operating the machine.

It is a further objective of the present invention to provide a Hybrid Energy Saving System which can be easily adapted to use with various types of high load-low load cyclic systems to minimize the load stress impacts to the mechanical system (metal fatigue).

It is further an objective of the present invention to minimize the impacts of noise and negative visual impact to the surrounding environment, both flora and fauna.

It is still another objective of the present invention to provide a Hybrid Energy Savings System which can be operated without monitoring by personnel for long periods of time. The operation of the system may occur either day or night.

It is still a further objective of the present invention to provide a Hybrid Energy Saving System that can be used in any high energy-low energy cyclic machine or equipment other than a pump system, less expensive with higher quality, safer, and with minimal impact to the local and global environment-carbon sequestration and global warming.

These and other objectives of the present invention will become apparent to those skilled in this art upon reading the accompanying description, drawings and claims set forth herein.

### BRIEF DESCRIPTION OF THE DRAWING

FIG. 1 is a side section view of the Hybrid Energy Saving System according to the present invention.

### DETAILED DESCRIPTION OF THE INVENTION

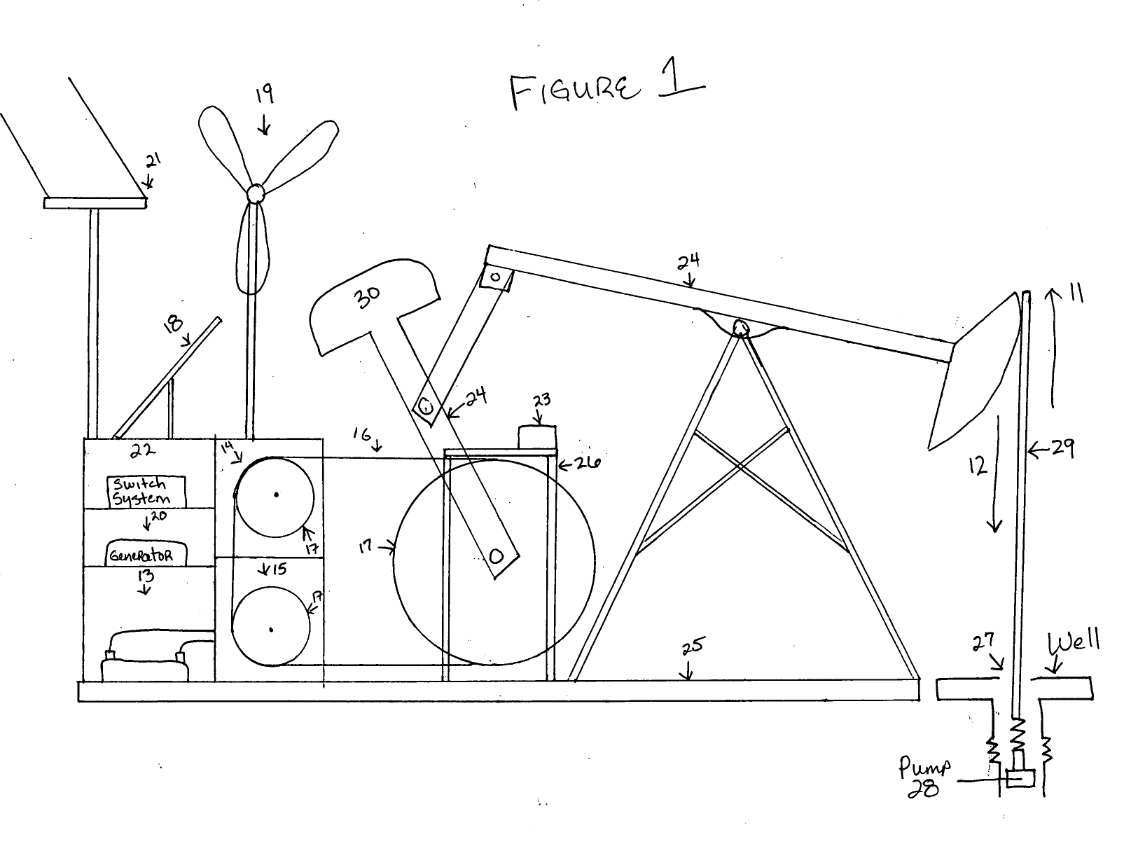

FIG. 1 shows a side sectional view of the best mode contemplated by the inventor of the Hybrid Energy Saving System 10 according to the concept of the present invention as can be seen from the drawing of an example Hybrid Energy Saving System on an oil or a water well pumping system. The Hybrid Energy Saving System in the example will deliver energy to the lift system on the up portion of the stroke, 11 and take back energy from the Hybrid Energy Saving System on the down stroke 12. A battery/capacitor system 13 will store the energy needed to operate the electric motor. An electric motor 14 will supply the machine (the pump) energy during the up stroke 11 and during the down stroke 12 electrical energy will be made by the generator 15. A belt 16 and pulley gear system 17 will connect the Hybrid Energy Saving System to the pump system. When the generator extracts energy from the system the process will slow the fall of the pump head by returning electric energy to the storage system.

The slowing of the fall of the pump head will protect the well structure by decreasing the peak loads (stress) on the system. The energy losses within the system will be made up by a solar array 18, a wind turbine 19, a natural gas or gas engine-generator 20, or connection to the electric grid 21.

A switching system will be attached to the main drive of the pump system 22 to disconnect the electric motor from the system at the top of the cycle and connect the energy generating system (generator). The reverse process will occur at the bottom of the cycle. A sensor system 23 will be placed on the pulley assembly 16 to initiate the changes from the high load (energy use) portion of the cycle to the low load (energy generation) portion of the cycle and return.

The problems addressed by the Hybrid Energy Saving System are many as can be seen by those skilled in the art. The Hybrid Energy Saving System decreases the mechanical loading (stress) on the pump jack system 24. The Hybrid Energy Saving System sits on a concrete pad 25. The support frame 26 contains the sensor system and supports the belt pulley system. The well 27 is under the head frame of the pump jack. The pump 28 is deep underground and is connected with a long sucker rod 29. The Hybrid Energy Saving System decreases the amount of energy lost on every cycle of the high load-low load system. The Hybrid Energy Saving System decreases the environmental noise impact. The Hybrid Energy storage System decreases the environmental impact from green house gas releases (global warming). Optimization of the Hybrid Energy Saving System will decrease or eliminate the need for a counter balance system 30 thus saving materials, design, and construction requirements.

The Hybrid Energy Saving System will find wide spread use anywhere that a high load-low load system is in operation. (A prime example is the use in a deep oil well or water well.)

Private industry would be employed to build the many units required. The savings in energy costs, equipment costs, environmental noise pollution costs, and the reduction in environmental impacts from reduction in green house gas releases and noise pollution would be large.

Thus, it will be appreciated by those skilled in the art that the present invention is not restricted to the particular preferred embodiment described herein with reference to the drawings, and that variations may be made therein without departing from the scope of the recent invention as defined in the appended claims and equivalents therein.

What is claimed is:

1. A Hybrid Energy Saving System comprising: an energy storage system made up of a battery or a battery-capacitor system to supply energy (electric); an electric motor to supply mechanical power (use energy) during the high load part of the cycle; an electric generator to retrieve the waste mechanical energy in the form of electrical energy and send the electrical energy to the battery during the low load part of the cycle; a system for switching the electric motor on and off and switching the electric generator off or on at the correct phases of the high load-low load cycle; an alternative electrical energy source such as solar or wind electric energy generating system, a gas electric energy generating system, or the electric grid to make up for the energy losses of the system.

2. A Hybrid Energy Saving System according to claim 1 which operates on an intermittent cycle.

3. A Hybrid Energy Saving System according to claim 1 which decreases the amount of carbon dioxide released to the environment during the operation of the high load-low load machine.

4. A Hybrid Energy Saving System according to claim 1 which minimizes the impact of noise to the surrounding environment.

5. A Hybrid Energy Saving System according to claim 1 which modifies the counter balance system to save materials, design and insulation costs while maximizing the energy return from the Hybrid Energy Saving System.

6. A Hybrid Energy Saving System according to claim 1 which will operate continuously for long periods of time without monitoring.

7. A Hybrid Energy Saving System according to claim 1 which will operate intermittently.

8. A Hybrid Energy Saving System according to claim 1 that is connected to any of the existing pump designs by belts, pulleys, cables, chains axles, pistons, cylinders, or other means which transfer mechanical energy.

9. A Hybrid Energy Saving System according to claim 1 which saves energy by reusing much of the energy stored within the system.

10. A Hybrid Energy Saving System according to claim 1 which has a sophisticated array of sensors to detect and change the operation of the system as it cycles through the high load to low load parts of the cycle.

11. A Hybrid Energy Saving System according to claim 1 which has a control system which controls the functions of the electric motor and the generator.

12. A Hybrid Energy Saving System according to claim 1 which has clutches, gears, belts, chains to engage and disengage the electric motor and the electric generator.

13. A Hybrid Energy Saving system according to claim 1 which switches the energy flow back and forth supplying mechanical energy to the pump system from the battery-electric motor part of the system and retrieving waste mechanical energy from the pump system through the use of the electric generator-battery part of the system as the machine progresses through it's cycle.

14. Hybrid Energy Saving System according to claim 1 which uses an alternative electrical energy source such as solar or wind electric energy generating systems, a gas, natural gas, or diesel electric energy generating system, or the electric grid to make up for the energy losses of the system.

15. Hybrid Energy Saving System according to claim 1 which modifies the well pump energy system to make the well pump system more visually aesthetic.

16. A method of extracting energy from a high load-low load mechanical device to generate electrical energy comprising the steps of: extracting the waste mechanical energy during the low load part of the cycle with a generator; sending the electrical energy to a storage device; switching the electric motor on and off to use the stored energy; switching the electric generator on and off to retrieve the waste mechanical energy; directing the switching of the electrical motor and the generator on and off with a sensor system; employing an alternative electrical energy source such as solar, wind, gas, natural gas, diesel electric engine or the electric grid to make up for the energy losses in the system.

17. A method of extracting energy according to claim 16 which decreases the amount of carbon dioxide released to the environment during the operation of the high load-low load machine.

18. A method of extracting energy according to claim 16 which collects the waste energy on an intermittent cycle.

19. A method of extracting energy according to claim 16 which decreases the amount of noise to the surrounding environment.

20. A method of extracting energy according to claim 16 which collects waste energy over a long period of time without being monitored.

21. A method of extracting energy according to claim 16 which increases the amount of waste energy collected through the optimization of the counter balance system.

22. A method of extracting energy according to claim 16 which increases the amount of waste energy collected by minimizing the energy losses from the existing pump designs by belts, pulleys, cables, chains, axles, pistons, cylinders, or other means which transfer mechanical energy.

23. A method of extracting energy according to claim 16 which maximizes the collection and distribution of waste energy using a sophisticated array of sensors to detect and change the operation of the system as it cycles through the high load to low load parts of the cycle.

24. A method of extracting energy according to claim 16 which maximizes the collection and distribution of waste energy using a control system which controls the functions of the electric motor and the generator.

25. A method of extracting energy according to claim 16 which maximizes the collection and distribution of energy through the optimization of the clutches, gears, belts, chains which engage and disengage the electric motor and the electric generator.

26. A method of extracting energy according to claim 16 which maximizes the collection and distribution of energy through the optimization of the energy flow to the pump system from the battery-electric motor part of the system and retrieving waste mechanical energy from the pump system through the use of the electric generator-battery part of the system as the machine progresses through it's cycle.

27. A method of minimizing the amount of additional electric energy needed to be supplied to the system to make up for energy losses according to claim 16 which minimizes collection and distribution from a solar or wind electric energy generating system, a gas natural gas or diesel electric energy generating system, or the electric grid.

28. A method of extracting energy according to claim 16 which allows feedback to the design and construction of the well energy system to make the well pump system more visually aesthetic.
